(19) United States
(12) Patent Application Publication
(10) Pub. No.: US 2025/0341389 A1
(43) Pub. Date: Nov. 6, 2025

(54) PHASE DETECTION DEVICE USING PHASE SHIFTING INCLUDING GEOMETRIC PHASE OPTICAL ELEMENT

(71) Applicant: PSI System Inc., Hwaseong-si Gyeonggi-do (KR)

(72) Inventor: Yeong Hwa RYU, Goyang-si Gyeonggi-do (KR)

(73) Assignee: PSI System Inc., Hwaseong-si Gyeonggi-do (KR)

(21) Appl. No.: 19/271,839

(22) Filed: Jul. 17, 2025

Related U.S. Application Data
(63) Continuation of application No. PCT/KR2023/018332, filed on Nov. 15, 2023.

(30) Foreign Application Priority Data
Mar. 13, 2023 (KR) 10-2023-0032567

(51) Int. Cl. G01B 9/02001

(52) U.S. Cl. CPC G01B 9/0201; G01B 9/02011; G01B 2290/70

(57) ABSTRACT

Disclosed is a phase detection device using phase shifting, the device including a geometric phase optical element. According to one aspect of the present embodiment, provided is a phase detection device characterized by comprising an optical mask for phase-shifting object light and reference light having different circular polarizations and generated through an interferometer, wherein the optical mask comprises: an optical array including geometric phase optical pixels that phase-delay the object light and the reference light by twice a predetermined optical axis rotation angle; and a circular polarization beam splitter which is configured to transmit some of circular polarization component transmitted through the optical array.

### CROSS-REFERENCE TO RELATED APPLICATIONS

This application is a continuation of International Application No. PCT/KR2023/018332, filed on Nov. 15, 2023, which claims priority to Korean Patent Application No. 10-2023-0032567, filed on Mar. 13, 2023, the entire contents of which are herein incorporated by reference.

### TECHNICAL FIELD

The present embodiment relates to a phase detection device that detects optical properties of object light in a phase shifting manner by using a geometrical phase optical element.

### BACKGROUND ART

Contents described in this part merely provide background information of the present embodiment, and do not constitute a conventional technology.

An optical test technique is developed from a conventional two-dimensional (2-D) shape test to a three-dimensional (3-D) shape test. Various technical attempts to detect phase or polarization properties in addition to the intensity of light reflected by an object are being made. Among them, a phase shifting interferometry method is used as a basic method of measuring a 3-D shape because a configuration optical system and calculation algorithm are simple.

In a conventional phase shifting method, the intensity and phase of light of object light reflected from a surface of an object are detected by using an element, such as a piezo-electric transducer (PZT) or a liquid crystal variable retarder (LCVR). In this case, in the conventional phase shifting method, a plurality of phase-shifted interference patterns is photographed by sequentially adjusting the phase of reference light reflected by a reference mirror. The aforementioned information is detected by using the interference patterns.

However, the conventional phase shifting method has a minute temporal interval in a process of obtaining the phase-shifted interference pattern because the phase-shifted interference pattern needs to be obtained by a plurality of pieces of photographing accompanied by the sequential adjustment of the PZT or LCVR. If irregular vibration is introduced from an environment during such a temporal interval, there is a problem in that phase detection performance of the conventional phase shifting method is degraded. However, it is difficult to expect high phase detection performance in the conventional phase shifting method in an industrial site because several irregular vibrations are always practically present in a common industrial site in which mass production is performed.

As a method of avoiding an error attributable to the introduction of vibration, a method of simultaneously photographing plurality of phase-shifted interference patterns by using a plurality of cameras is researched.

However, the corresponding method requires a separate device or work for matching because the pixels of each camera corresponding to a location, such as an object, need to be precisely matched. Furthermore, the corresponding method has disadvantages in that it is difficult to compactly implement an optical system because an additional space in which a plurality of cameras is disposed is required and a cost for a test device is increased because a plurality of expensive cameras is used.

Accordingly, there is a need to develop a technology for a new phase detection device, which overcomes a disadvantage in that a phase detection device is vulnerable to vibration attributable to the time-series photographing of the conventional phase shifting method and the phase detection device has a simple structure while not using a plurality of cameras and includes a cheap optical system.

### DISCLOSURE

### Technical Problem

An embodiment of the present disclosure is to provide a phase detection device which has a simple structure by using a geometrical phase optical element and can detect optical properties of object light robustly against external vibration.

### Technical Solution

According to one aspect of the present embodiment, there is provided a phase detection device including an optical mask configured to phase-shift object light and reference light having different circular polarizations generated through interferometry. The optical mask includes an optical array including a plurality of optical pixels that induce a geometrical phase effect that phase-shifts the object light and the reference light two times a predetermined optical axis rotation angle and a circular polarization beam splitter configured to transmit some circular polarization components, among circular polarization components that pass through the optical array.

According to one aspect of the present embodiment, the interferometry includes a light source configured to provide coherent light and a light source beam splitter configured to split light into the object light and the reference light.

According to one aspect of the present embodiment, in the circular polarization beam splitter, anisotropical materials or anisotropical structures form a spiral structure.

According to one aspect of the present embodiment, the circular polarization beam splitter reflects circular polarization that rotates in a rotation direction identical with a rotation direction of the spiral structure and transmits circular polarization that rotates in an opposite direction.

According to one aspect of the present embodiment, the phase detection device further includes a detection unit configured to detect an interference pattern that is formed by the object light and the reference light that pass through the circular polarization beam splitter.

According to one aspect of the present embodiment, the detection unit obtains a plurality of phase-shifted interference pattern images.

According to one aspect of the present embodiment, when receiving light having one polarization, the optical array outputs a polarization component identical with incident light and an opposite polarization component that is phase-retarded two times the optical axis rotation angle.

According to one aspect of the present embodiment, the optical pixel receives the object light at an identical point between the plurality of optical pixels adjacent to each other.

According to one aspect of the present embodiment, the optical pixels adjacent to each other have different optical axis rotation angles.

According to one aspect of the present embodiment, the optical pixel receives the object light at an identical point between at least three adjacent optical pixels.

According to one aspect of the present embodiment, there is provided a method of detecting, by a phase detection device, a phase of object light, including a detection process of detecting an interference pattern of object light and reference light that pass through an optical mask and that are detected by the detection unit, an acquisition process of obtaining a plurality of interference pattern images by grouping the interference pattern detected in the detection process based on optical axis rotation angles of geometrical phase optical pixels, and a detection process of detecting optical properties of the object light by using the plurality of interference pattern images obtained in the acquisition process.

According to one aspect of the present embodiment, the optical mask includes an optical array including geometrical phase optical pixels that phase-shift the object light and the reference light two times a predetermined optical axis rotation angle and a circular polarization beam splitter configured to transmit some circular polarization components, among circular polarization components that pass through the optical array.

### Advantageous Effects

As described above, according to an aspect of the present embodiment, there is an advantage in that optical properties of object light can be detected with a simple structure by using the geometrical phase optical element.

Furthermore, according to an aspect of the present embodiment, there is an advantage in that it may be robust against external vibration because a plurality of phase-shifted interference pattern images can be obtained by a single exposure.

### BRIEF DESCRIPTION OF DRAWINGS

FIG. 1 is a diagram illustrating a construction of a phase detection system according to an embodiment of the present disclosure.

FIG. 2 is a diagram illustrating a construction of the phase detection device according to an embodiment of the present disclosure.

FIG. 3 is a diagram illustrating a construction of interferometry according to an embodiment of the present disclosure.

FIG. 4 is a diagram illustrating a construction of an optical mask according to an embodiment of the present disclosure.

FIG. 5 is a diagram that describes optical properties of an optical array according to an embodiment of the present disclosure.

FIGS. 6A and 6B are diagrams illustrating material properties of a material that constitutes the optical array according to an embodiment of the present disclosure.

FIG. 7 is a diagram illustrating a structure of the optical array according to an embodiment of the present disclosure.

FIG. 8 is a diagram illustrating a structure and chiral volume grating property of a circular polarization beam splitter according to an embodiment of the present disclosure.

FIG. 9 is a diagram that describes optical properties of the circular polarization beam splitter according to an embodiment of the present disclosure.

FIG. 10 is a diagram that describes optical properties of the optical mask according to an embodiment of the present disclosure.

FIG. 11 is a diagram that exemplifies a process of detecting optical properties of the phase detection device according to an embodiment of the present disclosure.

FIG. 12 is a diagram illustrating a pixel structure of a phase-shifted interference pattern detected by a detection unit according to an embodiment of the present disclosure.

FIG. 13 is a flowchart illustrating a method of detecting, by the phase detection device according to an embodiment of the present disclosure, optical properties of a detection subject.

### DETAILED DESCRIPTION

The present disclosure may be changed in various ways and may have various embodiments. Specific embodiments are to be illustrated in the drawings and specifically described. It should be understood that the present disclosure is not intended to be limited to the specific embodiments, but includes all of changes, equivalents and/or substitutions included in the spirit and technical range of the present disclosure. Similar reference numerals are used for similar components while each drawing is described.

Terms, such as a first, a second, A, and B, may be used to describe various components, but the components should not be restricted by the terms. The terms are used to only distinguish one component from another component. For example, a first component may be referred to as a second component without departing from the scope of rights of the present disclosure. Likewise, a second component may be referred to as a first component. The term “and/or” includes a combination of a plurality of related and described items or any one of a plurality of related and described items.

When it is described that one component is “connected” or “coupled” to the other component, it should be understood that one component may be directly connected or coupled to the other component, but a third component may exist between the two components. In contrast, when it is described that one component is “directly connected to” or “directly coupled to” the other component, it should be understood that a third component does not exist between the two components.

Terms used in this application are used to only describe specific embodiments and are not intended to restrict the present disclosure. An expression of the singular number includes an expression of the plural number unless clearly defined otherwise in the context. In this specification, a term, such as “include” or “have”, is intended to designate the presence of a characteristic, a number, a step, an operation, a component, a part or a combination of them, and should be understood that it does not exclude the existence or possible addition of one or more other characteristics, numbers, steps, operations, components, parts, or combinations of them in advance.

All terms used herein, including technical terms or scientific terms, have the same meanings as those commonly understood by a person having ordinary knowledge in the art to which the present disclosure pertains, unless defined otherwise in the specification.

Terms, such as those defined in commonly used dictionaries, should be construed as having the same meanings as those in the context of a related technology, and are not construed as ideal or excessively formal meanings unless explicitly defined otherwise in the application.

Furthermore, each construction, process, procedure, or method included in each embodiment of the present disclosure may be shared within a range in which the constructions, processes, procedures, or methods do not contradict each other technically.

FIG. 1 is a diagram illustrating a construction of a phase detection system according to an embodiment of the present disclosure.

Referring to FIG. 1, a phase detection system 100 according to an embodiment of the present disclosure includes a phase detection device 110 and a server 120.

The phase detection system 100 detects a 3-D shape of a detection subject in real time. The phase detection system 100 detects the 3-D shape of the detection subject by measuring optical properties of object light reflected by the detection subject (e.g., a semiconductor, a display device, etc.). In this case, the measured optical properties include the phase, amplitude, and polarization component of the object light.

The phase detection device 110 detects the 3-D shape of the detection subject in real time as described above, and transmits the results of the detection to the server 120. The phase detection device 110 is implemented with a computing device, a PC, a server, a micro server, an edge computing server that performs multi-access edge computing (MEC), kiosk, a non-mobile computing device, or the like in various industrial field, and may perform the aforementioned operation.

The phase detection device 110 performs communication with the server 120 by using a network interface (not illustrated). The network interface (not illustrated), a short-range wireless communication unit may be implemented with a Bluetooth communication unit, a Bluetooth low energy (BLE) communication unit, a near field communication unit, a WLAN (Wi-Fi) communication unit, a Zigbee communication unit, an infrared data association (IrDA) communication unit, a Wi-Fi direct (WFD) communication unit, an ultra wideband (UWB) communication unit, an Ant+ communication unit, or the like. The phase detection device 110 may share optical properties of a detection subject and a 3-D shape detected from the optical properties with the server 120 by using a network interface (not illustrated).

The server 120 communicates with the phase detection device 110, and receives the results of detection from the phase detection device 110.

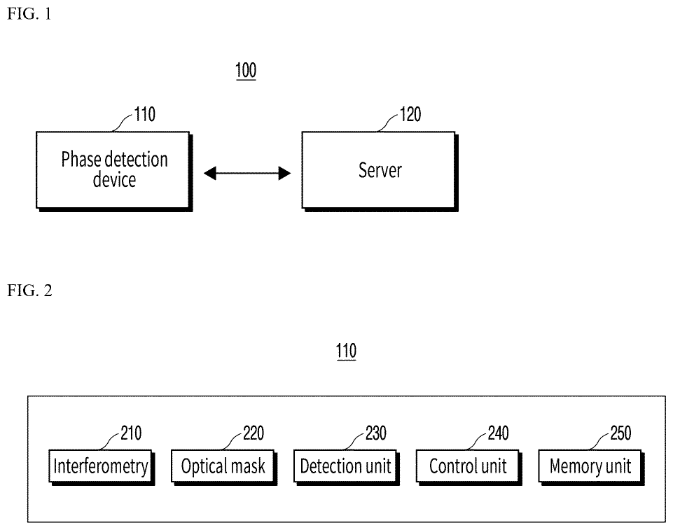

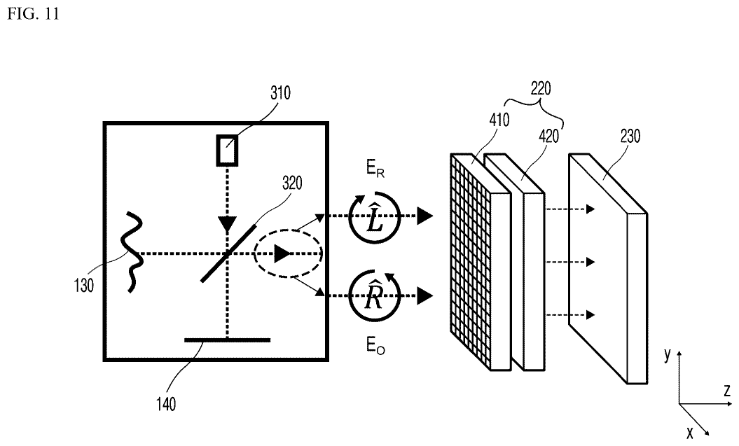

FIG. 2 is a diagram illustrating a construction of the phase detection device according to an embodiment of the present disclosure. FIG. 11 is a diagram that exemplifies a process of detecting optical properties of the phase detection device according to an embodiment of the present disclosure.

Referring to FIG. 2, the phase detection device 110 according to an embodiment of the present disclosure includes interferometry 210, an optical mask 220, a detection unit 230, a control unit 240, and a memory unit 250.

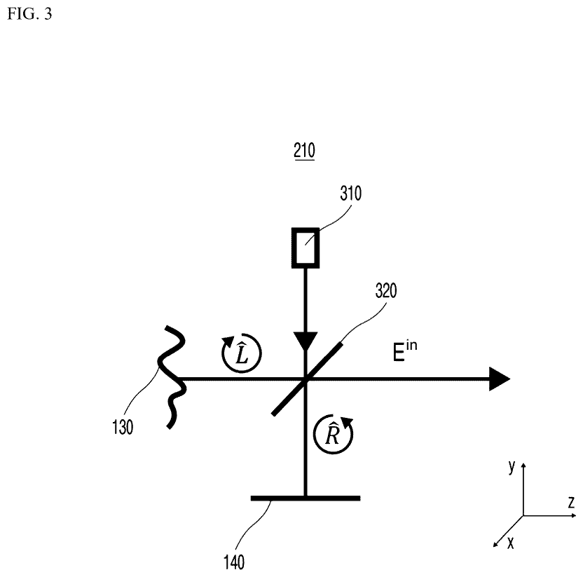

The interferometry 210 generates interference light including optical properties of a detection subject by radiating light to the detection subject. The interferometry 210 may be implemented with a structure illustrated in FIG. 3.

FIG. 3 is a diagram illustrating a construction of the interferometry according to an embodiment of the present disclosure.

Referring to FIG. 3, the interferometry 210 according to an embodiment of the present disclosure includes a light source 310 and a beam splitter 320.

The light source 310 radiates light toward the beam splitter 320.

The beam splitter 320 branches the light radiated by the light source 310 to a detection subject 130 and a reference mirror 140, and makes light reflected by the subjects 130 and 140 proceed to the same path. The beam splitter 320 forms object light reflected by the detection subject 130 and reference light reflected by the reference mirror 140 by branching the light radiated by the light source 310 toward the detection subject 130 and the reference mirror 140. The beam splitter 320 makes the object light and the reference light proceed interfere with each other while making the object light and the reference light proceed to the same path by reflecting any one of the object light and the reference light and transmitting the other of the object light and the reference light.

The interferometry 210 is implemented with such a structure, and thus generates interference light including optical properties of a detection subject and makes the interference light proceed to the optical mask 220.

FIG. 3 illustrates that the interferometry 210 includes only the beam splitter 320, but the present disclosure is not limited thereto. The interferometry may be substituted with any two-beam interferometry, such as Mach-Zehnder interferometry, Sagnac interferometry, or the like.

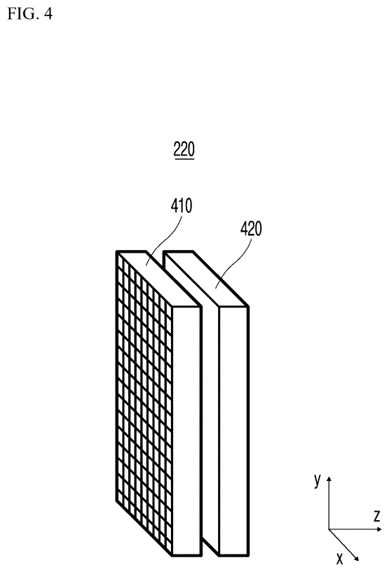

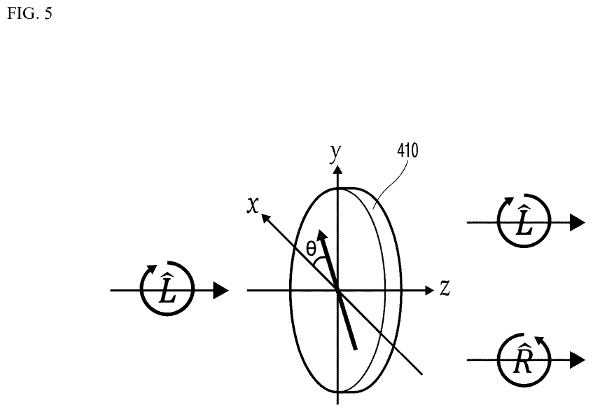

Referring back to FIG. 2, the optical mask 220 generates a plurality of phase-shifted interference patterns by receiving interference light that has experienced the interferometry 210. The optical mask 220 may generate the plurality of phase-shifted interference patterns although the optical mask includes a plurality of pieces of photographing or a plurality of detection units as in a conventional technology by using a geometrical phase optical element. A detailed structure and operation of the optical mask 220 is illustrated in FIGS. 4 to 10.

FIG. 4 is a diagram illustrating a construction of the optical mask according to an embodiment of the present disclosure.

Referring to FIG. 4, the optical mask 220 according to an embodiment of the present disclosure includes an optical array 410 and a circular polarization beam splitter 420.

The optical array 410 receives interference light subjected to interference in the interferometry 210, induces the phase shifting of the interference light, but autonomously induces the phase shifting of the interference light at a different angle.

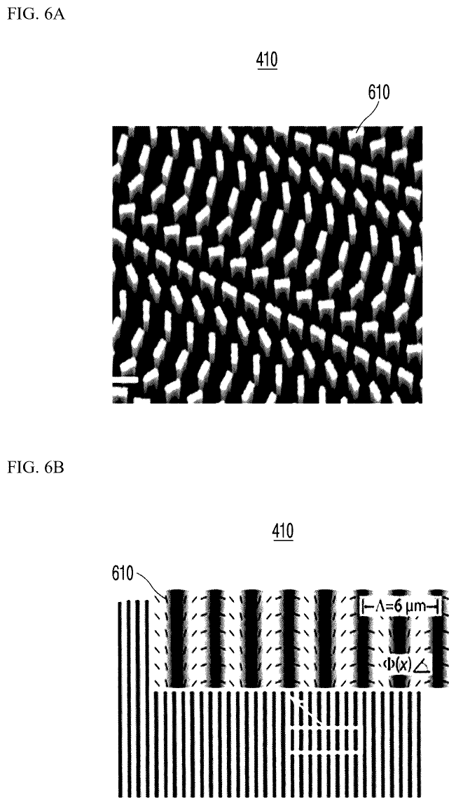

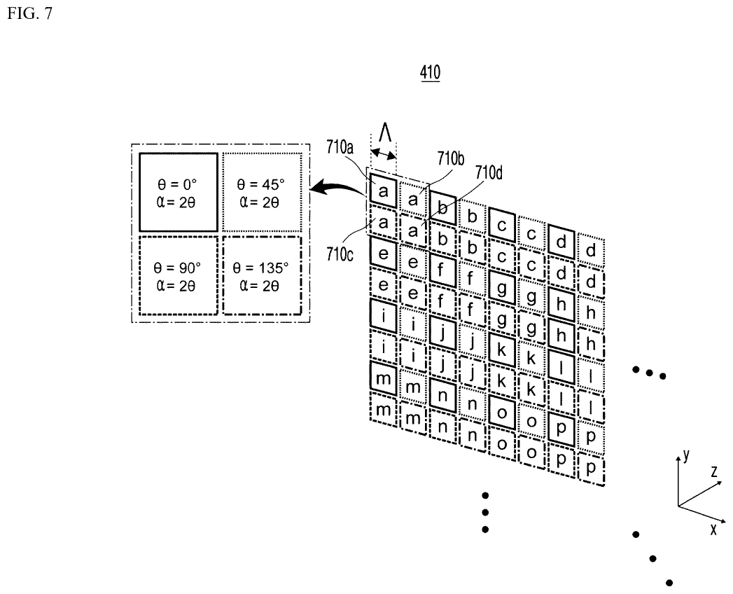

As illustrated in FIGS. 5 and 6, the optical array 410 induces the phase shifting of interference light that is incident thereto because the optical array is implemented with a geometrical phase optical element.

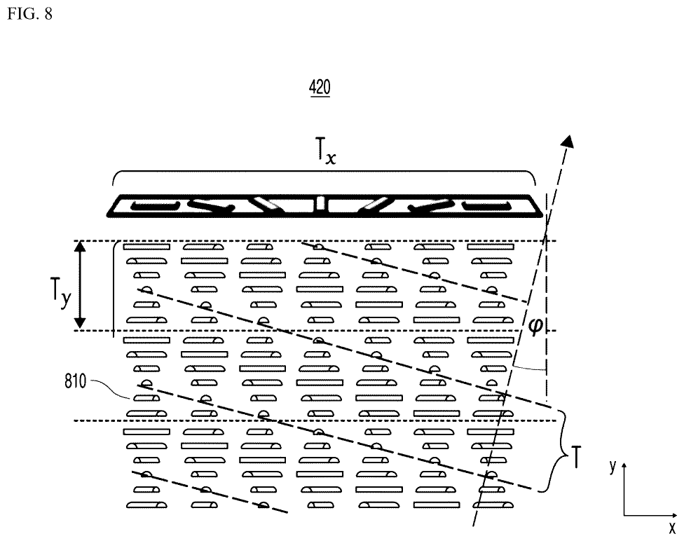

FIG. 5 is a diagram that describes optical properties of an optical array according to an embodiment of the present disclosure. FIGS. 6A and 6B are diagrams illustrating material properties of a material that constitutes the optical array according to an embodiment of the present disclosure. FIG. 7 is a diagram illustrating a structure of the optical array according to an embodiment of the present disclosure.

The optical array 410 is implemented with a geometrical phase optical element. The optical array 410 is implemented to have a structure having a meta surface illustrated in FIG. 6A, but may be implemented to have a structure including liquid crystals.

As illustrated in FIG. 6A, the optical array 410 may be implemented to have the structure having the meta surface. An anisotropical structure 610 having the meta surface may be formed of a high refractive index material having a rectangular cross section and a high pillar shape, and may be disposed in a form in which the anisotropical structure has been rotated for each local position. The rectangular cross section of the high refractive index material, which has a smaller nano size than a propagation wavelength, indicates optical anisotropy, and the rotation arrangement of the high refractive index material induces the rotation of an optical axis. The anisotropical structures 610 each having the meta surface may be manufactured by an e-beam lithography process or a semiconductor process for precisely manufacturing the nano-size structure.

Alternatively, as illustrated in FIG. 6B, the optical array 410 may be implemented with the anisotropical structure 610 based on liquid crystals. The structure 610 may be disposed in a form in which the structure has been rotated like the arrangement of a value Φ(x), that is, a liquid crystal arrangement direction, for each local position because the anisotropical structure 610 based on liquid crystals itself indicates the properties of the anisotropical material, and thus may induce a geometrical phase effect. If the optical array 410 is implemented with the anisotropical structure based on liquid crystals, the optical array can be produced relatively cheaply.

As described above, the optical array 410 implemented with the geometrical phase optical elements has optical properties illustrated in FIG. 5. The optical array 410 generates an additional geometrical phase shifting phenomenon attributable to a difference in the direction of the optical axis of anisotropical materials. Accordingly, if the optical array 410 is implemented with an anisotropical material having Γ, that is, phase retardance, when light having circular polarization in one direction is incident on the optical array 410, the following output light is output.

$$T = R ( - Θ ) \cdot ( \begin{matrix}1 & 0 \\ 0 & {e}^{i Γ}\end{matrix} ) \cdot R ( Θ ) = ( \begin{matrix}cos θ & sin θ \\ - sin θ & cos θ\end{matrix} ) ( \begin{matrix}1 & 0 \\ 0 & {e}^{- i Γ}\end{matrix} ) ( \begin{matrix}cos θ & - sin θ \\ sin θ & cos θ\end{matrix} )$$

$${E}^{in} = \frac{1}{\sqrt{2} ( \begin{matrix}1 \\ \pm i\end{matrix} )} = \hat{R} or L , R = \frac{1}{\sqrt{2}} ( \begin{matrix}1 \\ + i\end{matrix} ) ,$$

$$\hat{L} = \frac{1}{\sqrt{2}} ( \begin{matrix}1 \\ - i\end{matrix} ) {E}^{GP} = T \cdot {E}^{in} = cos ( \frac{Γ}{2} ) \frac{1}{\sqrt{2}} ( \begin{matrix}1 \\ \pm i\end{matrix} ) - i sin ( \frac{Γ}{2} ) {e}^{i ( \pm 2 θ )} \frac{1}{\sqrt{2}} ( \begin{matrix}1 \\ ∓ i\end{matrix} ) = cos ( \frac{Γ}{2} ) \frac{1}{\sqrt{2}} ( \begin{matrix}1 \\ \pm i\end{matrix} ) + sin ( \frac{Γ}{2} ) {e}^{i ( \pm 2 θ - \frac{π}{2} )} \frac{1}{\sqrt{2}} ( \begin{matrix}1 \\ ∓ i\end{matrix} ) Γ = \frac{2 π}{λ} ( {n}_{e} - {n}_{o} ) .$$

In this case, T denotes a Jones matrix. Eⁱⁿ denotes incident light that is incident on the optical array 410. E^{GP} denotes output light that is output by the optical array 410. [symbol] denotes right circular polarization. \hat{L} denotes left circular polarization. Θ denotes the optical axis rotation angle of the anisotropical material. nₑ denotes the refractive index of the anisotropical material in a fast axis. nₒ denotes the refractive index of the anisotropical material in a slow axis. t denotes the thickness of the anisotropical material in a light progress direction.

According to the aforementioned equation, when light having one polarization is incident on the optical array 410, the same polarization component (a component including the cos term within the equation, which is related to the output light) as the incident light and an opposite polarization component (a component including the sin term within the equation, which is related to the output light) having a phase shifted (retarded) two times the optical axis rotation angle of the anisotropical material are output.

Meanwhile, as illustrated in FIG. 7, the optical array 410 having such a property is implemented with the anisotropical material that induces a geometrical phase effect, but includes a plurality of optical pixels 710 implemented in an array form.

In this case, each of the optical pixels 710 does not receive interference light at a different point (of an detection subject) as in a conventional technology, but a plurality of (at least three) adjacent optical pixels 710a to 710d receives interference light at the same point (of the detection subject). However, the optical pixels 710 that receive the interference light at the same point are likewise implemented with the anisotropical material having the aforementioned property, but have different optical axis rotation angles. For example, as exemplified in FIG. 7, assuming that four optical pixels 710a to 710d that are adjacent to each other horizontally (an x axis direction) and vertically (a y axis) receive interference light at the same point, the optical pixels 710a to 710d may have optical axis rotation angles of 0°, 45°, 90°, and 135°, respectively.

Accordingly, phase shifting of 0°, 90°, 180°, and 270°, that is, two times the optical axis rotation angles, occur in polarization components that are included in the pieces of incident light that pass through the optical pixels 710a to 710d and that each have a phase shifted (retarded).

As described above, assuming that the number of optical pixels 710a to 710d that receive the interference light at the same point within the optical array 410 is n and the size of the pixel within the detection unit 230 is Λ, the optical pixels 710a to 710d within the optical array 410 may be disposed by being repeated in a nΛ cycle. In FIG. 7, the optical pixels 710a to 710d may be disposed by each being repeated in the 2Λ cycle horizontally and vertically within the optical array 410 because the optical pixels are disposed to be adjacent to each other horizontally and vertically.

The optical array 410 having such an arrangement of the optical pixels 710 may obtain all of phase-shifted interference patterns for analyzing optical properties of a detection subject although the optical array receives interference light only once. Accordingly, the optical array 410 can fundamentally block an influence attributable to disturbance, such as vibration, in a process of obtaining all of the interference patterns having different phase shifting angles as in a conventional technology, and also does not need to have a plurality of detection units. Only the optical mask 220 having a very small thickness has only to be disposed at the front end of one detection unit 230. Accordingly, the total volume of the optical mask 220 or the phase detection device 110 including the optical mask can be significantly reduced because the optical array can have a simple structure.

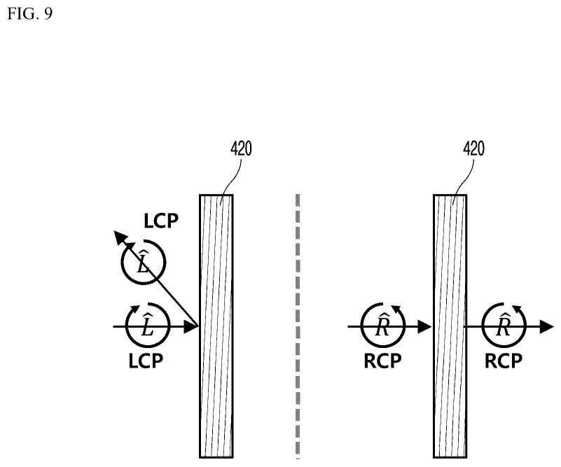

Referring back to FIG. 4, having light each polarization component, which is output by the optical array 410, is incident on the circular polarization beam splitter 420. The circular polarization beam splitter 420 may operate as illustrated in FIG. 9 because the circular polarization beam splitter has properties illustrated in FIG. 8.

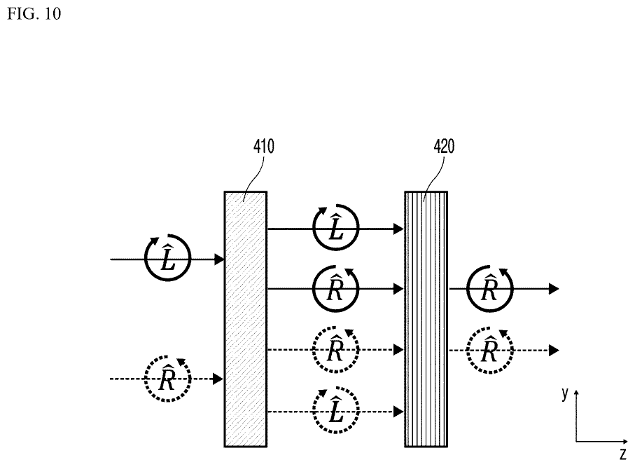

FIG. 8 is a diagram illustrating a structure and chiral volume grating property of a circular polarization beam splitter according to an embodiment of the present disclosure. FIG. 9 is a diagram that describes optical properties of the circular polarization beam splitter according to an embodiment of the present disclosure. FIG. 10 is a diagram that describes optical properties of the optical mask according to an embodiment of the present disclosure.

Referring to FIG. 8, the circular polarization beam splitter 420 has a spiral structure, that is, chirality. An element in which anisotropical structures 810 have their molecular directions sequentially rotated and arranged in a vertical axis (y axis) direction is called a chiral element. For example, if a chiral dopant is added to nematic liquid crystals in which all of liquid crystal molecules are directed in a constant direction, the chiral dopant may induce the chiral alignment of the nematic liquid crystals. In this case, the cycle T_{y} of the chirality may be determined based on a concentration of the chiral dopant.

Furthermore, if the boundary surfaces of liquid crystals are aligned to have an alignment cycle Tₓ by using various methods, a chiral liquid crystal alignment layer may be manufactured by volume grating. In general, the propagation of light in the volume grating satisfies a Bragg diffraction condition between propagation constants of incident light and output light and a grating vector, according to a Floquet theory.

Due to such a condition, the circular polarization beam splitter 420 operates as illustrated in FIG. 9. The circular polarization beam splitter 420 reflects a circular polarization component having the same rotation direction as its spiral structure, among pieces of light incident thereon, and transmits a circular polarization component that is rotated in an opposite direction. More specifically, the circular polarization beam splitter 420 can perform a function of a selective mirror or a beam splitter in the polarization direction of the incident light because the volume grating property selectively appears in the circular polarization direction of the incident light. For example, if the circular polarization beam splitter 420 has left helicity as illustrated in FIG. 9, the circular polarization beam splitter may reflect a left circular polarization component and transmit only a right circular polarization component, among pieces of light incident thereon.

The optical mask 220 operates as illustrated in FIG. 10 because the optical mask includes the optical array 410 having the aforementioned properties and the circular polarization beam splitter 420.

As described above, when object light polarized in one direction (e.g., left circular polarization) and reference light polarized in another direction (e.g., right circular polarization) are incident on the optical array 410, the pieces of light are output as the same polarization component as that of the incident light without phase shifting and an opposite polarization component that has been phase-shifted, respectively, while passing through the optical array 410.

The light that is output by the optical array 410 is incident on the circular polarization beam splitter 420. The circular polarization beam splitter reflects only one polarization component (e.g., the left circular polarization) and transmits the other polarization component, among polarization components incident thereon. Any one polarization component, among the one polarization components passing through the circular polarization beam splitter, is light having a phase not shifted, and the other polarization component, among the one polarization components, corresponds to light having a phase shifted two times the optical axis rotation angle. Components that pass through the circular polarization beam splitter 420 interfere with each other, thus forming an interference pattern, and proceed to the detection unit 230.

For example, if the thickness Γ of the optical array 410 has been adjusted as π/2, the following interference pattern is formed in interference light that passes through the optical mask 220.

$$\begin{matrix}{E}_{o}^{in} = \hat{L} {A}_{o} {e}^{i {ϕ}_{o}} \\ {E}_{R}^{in} = \hat{R} {A}_{R} {e}^{i {ϕ}_{R}}\end{matrix}$$

$${E}_{o}^{GP} = \frac{1}{\sqrt{2}} \hat{L} {A}_{o} {e}^{i {ϕ}_{o}} + \frac{1}{\sqrt{2}} \hat{R} {A}_{o} {e}^{i ( {ϕ}_{o} + 2 θ - \frac{π}{2} )}$$

$${E}_{R}^{GP} = \frac{1}{\sqrt{2}} \hat{R} {A}_{R} {e}^{i {ϕ}_{R}} + \frac{1}{\sqrt{2}} \hat{L} {A}_{R} {e}^{i ( {ϕ}_{R} + 2 θ - \frac{π}{2} )}$$

$$I ( θ ) = {\vert {E}_{o}^{CM} + {E}_{R}^{CM} \vert}^{2} = {\vert \frac{1}{\sqrt{2}} \hat{R} {A}_{o} {e}^{i ( {ϕ}_{o} - 2 θ - \frac{π}{2} )} + \frac{1}{\sqrt{2}} \hat{R} {A}_{R} {e}^{i {ϕ}_{R}} \vert}^{2} = \frac{1}{2} [ {A}_{o}^{2} + {A}_{R}^{2} + 2 {A}_{O} {A}_{R} cos ( {ϕ}_{R} - {ϕ}_{o} + 2 θ + \frac{π}{2} ) ]$$

In this case,

$${E}_{o}^{i \text{?}}$$

$$\text{?} \text{indicates text missing or illegible when filed}$$

denotes an object light component of the incident light.

$${E}_{R}^{i \text{?}}$$

$$\text{?} \text{indicates text missing or illegible when filed}$$

denotes a reference light component of the incident light.

$${E}_{o}^{G \text{?}}$$

$$\text{?} \text{indicates text missing or illegible when filed}$$

denotes an object light component that passes through the optical array 410.

$${E}_{R}^{G \text{?}}$$

$$\text{?} \text{indicates text missing or illegible when filed}$$

denotes a reference light component that passes through the optical array 410.

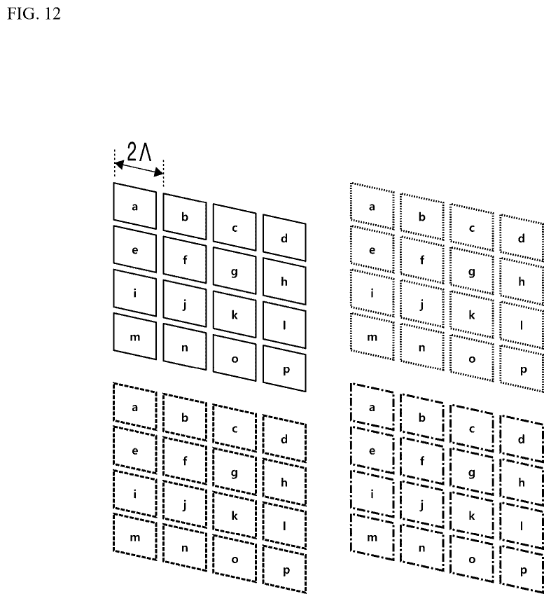

Referring back to FIG. 2, the detection unit 230 receives a plurality of phase-shifted interference patterns that passes through the optical mask 220, and measures the optical properties of the object light reflected from the detection subject based on the received interference patterns. As illustrated in FIG. 12, the detection unit 230 may obtain (a plurality of) phase-shifted interference pattern images phase-shifted at the same angle based on the optical axis rotation angles.

FIG. 12 is a diagram illustrating a pixel structure of a phase-shifted interference pattern detected by the detection unit according to an embodiment of the present disclosure.

Referring to FIGS. 12A and 12B, the detection unit 230 may obtain a plurality of phase-shifted interference patterns by grouping a plurality of interference patterns that has been phase-shifted at the same angle based on the optical axis rotation angles. The detection unit 230 may detect optical properties (a phase, amplitude, and polarization) of the object light from the plurality of obtained phase-shifted interference patterns.

The detection unit 230 may detect the amplitude of the object light, the amplitude of the reference light, and the phase of the object light to the reference light as follows because the detection unit can receive at least three interference patterns shifted at different angles from the optical mask 220.

$$ϕ = {tan}^{- 1} [ \frac{I ( \frac{π}{2} ) - I ( \frac{3 π}{2} )}{I ( \frac{0 \cdot π}{2} ) - I ( \frac{2 π}{2} )} ]$$

$${A}_{R}^{2} or {A}_{o}^{2} = \frac{1}{2} [ S \pm \sqrt{{S}^{2} - ( {D}_{13}^{2} + {D}_{02}^{0} )} ]$$

$$S = I ( \frac{0 \cdot π}{2} ) + I ( \frac{2 π}{2} ) = {A}_{R}^{2} + {A}_{o}^{2}$$

$${D}_{02} = I ( \frac{0 \cdot π}{2} ) - I ( \frac{2 π}{2} ) = 2 {A}_{R} {A}_{o} cos ϕ$$

$${D}_{13 = I} ( \frac{1 \cdot π}{2} ) + I ( \frac{3 π}{2} ) = 2 {A}_{R} {A}_{o} sin ϕ$$

Through the aforementioned process, the detection unit 230 may detect the phase and amplitude of the object light.

Furthermore, the detection unit 230 may detect the polarization of the object light by using the plurality of received interference patterns. The detection unit 230 may detect Stokes' parameters {S0, S1, S2, S3}) indicative of the polarization of light based on the amplitude of the left circular polarization, the phase of the left circular polarization, the amplitude of the right circular polarization, and the phase of the right circular polarization. The detection unit 230 may detect the Stokes' parameters based on the following equations.

$$E = \hat{R} {A}_{r} {e}^{i {ϕ}_{r}} + \hat{L} {A}_{l} {e}^{i {ϕ}_{l}} = \hat{x} {A}_{x} {e}^{i {ϕ}_{x}} + \hat{y} {A}_{y} {e}^{i {ϕ}_{y}}$$

$${A}_{x} {e}^{i {ϕ}_{x}} = \frac{1}{\sqrt{2}} [ - {A}_{r} sin {ϕ}_{r} + {A}_{l} sin {ϕ}_{l} ] + i \frac{1}{\sqrt{2}} [ {A}_{r} cos {ϕ}_{r} - {A}_{l} cos {ϕ}_{l} ] = {a}_{x} + {ib}_{x}$$

$${A}_{x} = \sqrt{{a}_{x}^{2} + {b}_{x}^{2} ,} {ϕ}_{x} = {tan}^{- 1} ( \frac{{b}_{x}}{{a}_{x}} )$$

$${A}_{y} {e}^{i {ϕ}_{y}} = \frac{1}{\sqrt{2}} [ - {A}_{r} sin {ϕ}_{r} + {A}_{l} sin {ϕ}_{l} ] + i \frac{1}{\sqrt{2}} [ {A}_{r} cos {ϕ}_{r} - {A}_{l} cos {ϕ}_{l} ] = {a}_{y} + {ib}_{y}$$

$${A}_{y} = \sqrt{{a}_{y}^{2} + {b}_{y}^{2} ,} {ϕ}_{y} = {tan}^{- 1} ( \frac{{b}_{y}}{{a}_{y}} )$$

In this case, Ar denotes the amplitude of the right circular polarization. ϕᵣ denotes the phase of the right circular polarization. Al denotes the amplitude of the left circular polarization. [symbol] denotes the phase of the left circular polarization.

In this case, the Stokes' parameters are calculated as follows.

$${S}_{0} = {A}_{x}^{2} + {A}_{y}^{2} ,$$

$${S}_{1} = {A}_{x}^{2} - {A}_{y}^{2} ,$$

$${S}_{2} = 2 {A}_{x} {A}_{y} cos ( {ϕ}_{y} - {ϕ}_{x} ) ,$$

$${S}_{3} = 2 {A}_{x} {A}_{y} sin ( {ϕ}_{y} - {ϕ}_{x} )$$

The detection unit 230 may detect the polarization state from the amplitude and phase of the object light as in the aforementioned process.

Accordingly, although the phase detection device 110 receives the interference light from the detection subject only once, the detection unit 230 can detect the optical properties of the object light. Accordingly, the detection unit 230 can detect a 3-D shape (of the detection subject) having a pixel size of Λ.

Referring back to FIG. 2, the control unit 240 controls the aforementioned operations of the components within the phase detection device 110. The control unit 240 may control the aforementioned operations of the components within the phase detection device 110 by executing programs stored in the memory unit 250. Furthermore, the control unit 240 may be constituted with one or a plurality of processors, and may be implemented with a general-purpose processor, such as a CPU, an AP, and a digital signal processor (DSP), or a graphic-dedicated processor, such as a GPU or a vision processing unit (VPU).

The memory unit 250 may store one or more instructions which enable the aforementioned operations of the components within the phase detection device 110 to be executed.

The memory unit 250 may be implemented with a flash memory type, a hard disk type, a multimedia card micro type, card type memory (e.g., SD or XD memory), random access memory (RAM), static RAM (SRAM), read-only memory (ROM), electrically erasable programmable ROM (EEPROM), programmable ROM (PROM), magnetic memory, a magnetic disk, or an optical disk.

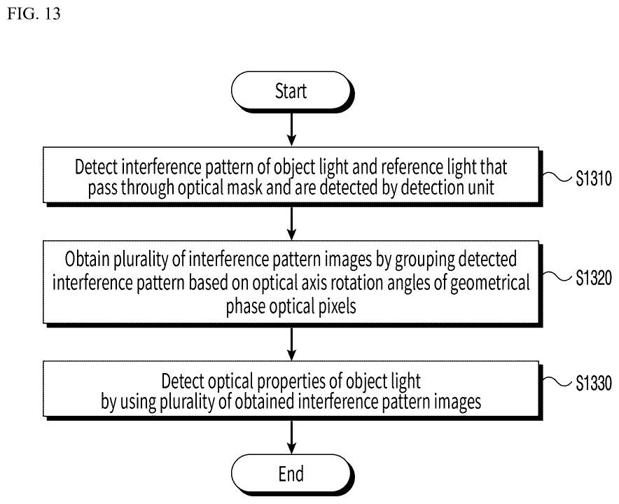

FIG. 13 is a flowchart illustrating a method of detecting, by the phase detection device according to an embodiment of the present disclosure, optical properties of a detection subject.

The detection unit 230 detects an interference pattern of object light and reference light that pass through the optical mask 220 (S1310). The detection unit 230 detects an interference pattern that is formed by the object light that is one-polarized and the reference light polarized in the same direction, which pass through the optical mask 220.

The detection unit 230 obtains a plurality of interference pattern images by grouping the detected interference pattern based on optical axis rotation angles of the geometrical phase optical pixels (S1320).

The detection unit 230 detects the optical properties of the object light by using the plurality of obtained interference pattern images (S1330).

The processes in FIG. 13 have been described as being sequentially executed, but this merely illustrates the technology spirit of an embodiment of the present disclosure. In other words, a person having ordinary knowledge in the art to which an embodiment of the present disclosure pertains may variously modify and change the processes by changing and executing the sequence described in each figure or executing one or more of the processes in parallel within a range that does not deviate from the intrinsic characteristic of an embodiment of the present disclosure. Accordingly, the processes in FIG. 13 are not limited to the time-series sequence.

Meanwhile, the processes illustrated in FIG. 13 may be implemented in a computer-readable recording medium in the form of a computer-readable code. The computer-readable recording medium includes all types of recording devices in which data readable by a computer system is stored. That is, the computer-readable recording medium includes storage media, such as magnetic storage media (e.g., ROM, a floppy disk, and a hard disk) and optical reading media (e.g., CD-ROM and a DVD). Furthermore, the computer-readable recording medium may be distributed to computer systems connected over a network, and the computer-readable code may be stored and executed in a distributed manner.

The above description is merely a description of the technical spirit of the present embodiment, and those skilled in the art may change and modify the present embodiment in various ways without departing from the essential characteristic of the present embodiment. Accordingly, the embodiments should not be construed as limiting the technical spirit of the present embodiment, but should be construed as describing the technical spirit of the present embodiment. The technical spirit of the present embodiment is not restricted by the embodiments. The range of protection of the present embodiment should be construed based on the following claims, and all of technical spirits within an equivalent range of the present embodiment should be construed as being included in the scope of rights of the present embodiment.

1. A phase detection device comprising:
an optical mask configured to phase-shift object light and reference light having different circular polarizations generated through interferometry,
wherein the optical mask comprises:
an optical array comprising a plurality of optical pixels that induce a geometrical phase effect that phase-shifts the object light and the reference light two times a predetermined optical axis rotation angle; and
a circular polarization beam splitter configured to transmit some circular polarization components, among circular polarization components that s through the optical array.

2. The phase detection device of claim 1, wherein the interferometry comprises:
a light source configured to provide coherent light; and
a light source beam splitter configured to split light into the object light and the reference light.

3. The phase detection device of claim 1, wherein in the circular polarization beam splitter, anisotropical materials or anisotropical structures form a spiral structure.

4. The phase detection device of claim 3, wherein the circular polarization beam splitter reflects circular polarization that rotates in a rotation direction identical with a rotation direction of the spiral structure and transmits circular polarization that rotates in an opposite direction.

5. The phase detection device of claim 1, further comprising a detection unit configured to detect an interference pattern that is formed by the object light and the reference light that pass through the circular polarization beam splitter.

6. The phase detection device of claim 5, wherein the detection unit obtains a plurality of phase-shifted interference pattern images.

7. The phase detection device of claim 1, wherein when receiving light having one polarization, the optical array outputs a polarization component identical with incident light and an opposite polarization component that is phase-retarded two times the optical axis rotation angle.

8. The phase detection device of claim 7, wherein the optical pixel receives the object light at an identical point between the plurality of optical pixels adjacent to each other.

9. The phase detection device of claim 8, wherein the optical pixels adjacent to each other have different optical axis rotation angles.

10. The phase detection device of claim 8, wherein the optical pixel receives the object light at an identical point between at least three adjacent optical pixels.

11. A method of detecting, by a phase detection device, a phase of object light, the method comprising:
a detection process of detecting an interference pattern of object light and reference light that pass through an optical mask and that are detected by a detection unit;
an acquisition process of obtaining a plurality of interference pattern images by grouping the interference pattern detected in the detection process based on optical axis rotation angles of geometrical phase optical pixels; and
a detection process of detecting optical properties of the object light by using the plurality of interference pattern images obtained in the acquisition process.

12. The method of claim 11, wherein the optical mask comprises:
an optical array comprising geometrical phase optical pixels that phase-shift the object light and the reference light two times a predetermined optical axis rotation angle; and
a circular polarization beam splitter configured to transmit some circular polarization components, among circular polarization components that pass through the optical array.
